(19) United States
(12) Patent Application Publication
(10) Pub. No.: US 2023/0269835 A1
(43) Pub. Date: Aug. 24, 2023

(54) THERMAL IMMERSION DEVICE

(71) Applicant: BREVILLE PTY LIMITED, Alexandria, New South Wales (AU)

(72) Inventors: William Yin Zhe SHEN, Alexandria (AU); Alfred Gar-Wo CHING, Alexandria (AU); Eva NG, Alexandria (AU); Han TANG, Alexandria (AU); Bryce James WAYLAND, Alexandria (AU); Marian Silviu ROSIAN, Alexandria (AU)

(21) Appl. No.: 18/012,789

(22) PCT Filed: Jun. 30, 2021
(86) PCT No.: PCT/AU2021/050699

§ 371 Date: Dec. 23, 2022

(30) Foreign Application Priority Data
Jul. 1, 2020 (AU) 2020902239

(51) Int. Cl. H05B 3/80

(52) U.S. Cl. CPC H05B 3/80

(57) ABSTRACT

A thermal immersion circulator comprising a housing defining a cavity, a heater comprising a heating element, wherein at least a portion of the heating element is located within the cavity of the housing, a coupling assembly securing the heater within the housing, and a seal isolating the coupling assembly from direct contact with the heater. The heater comprises a side surface having longitudinal axis, a fluid inlet in communication with a fluid outlet, and a fluid heating portion located between the fluid inlet and the fluid outlet. The heater also comprises at least one seal located adjacent the outlet and a heating element wrapped at least partially about the fluid heating portion. The heating element comprises a plurality of resistive bands arranged on the tubular side wall such that a first portion of a resistive band adjacent the fluid outlet is longitudinally spaced further from the fluid outlet than an opposing second portion of the resistive band to reduce transfer of heat generated by the resistive band to the seal whilst heating the fluid substantially along a longitudinal length of the fluid heating portion.

### RELATED APPLICATIONS

The present application claims priority from Australian Provisional Patent Application No. 2020902239, filed 1 Jul. 2020, the contents of which is herein incorporated by reference in its entirety.

### FIELD

The present disclosure generally relates to an electrically powered thermal immersion circulator to heat various fluids. In particular, the present invention relates water ingress protection for an electrically powered thermal immersion circulator.

### BACKGROUND

Thermal immersion circulators can be used to circulate and heat various fluids, such as to maintain a body of the fluid at an accurate and stable temperature. A thermal immersion circulator can include a pump or other mechanism to circulate the fluid, and a heating element to heat the fluid. Thermal immersion circulators have been used in applications such as scientific or other laboratories, and in kitchens, in particular, for sous vide cooking.

Parts around the heater of the thermal immersion circulator are exposed to temperatures in excess of 400° C. during a thermal fuse abnormal test. Such abnormal testing can result in distortion of plastic parts of the thermal immersion circulator.

As shown in FIG. 21 of US20190124722A1, a thermal immersion circulator has two seals. One of the two seals is in direct contact with the heating element. Such an arrangement of the seal and other plastic couplings with respect to the heating element may result in damage of the seal and surrounding plastic couplings under abnormal testing. For example, water seals can fail after the thermal fuse abnormal test which can result in the thermal immersion circulator not meeting requirements of water immersion tests, such as IPX7.

Compliance with water immersion tests, such as IPX7, is preferred to ensure safe use of the thermal immersion circulator under different conditions.

### SUMMARY OF INVENTION

It is an object of the present invention to substantially overcome, or at least ameliorate, one or more of disadvantages outlined above, or provide a useful alternative.

According to one aspect of the present disclosure, there is provided a thermal immersion circulator comprising: a housing defining a cavity; a heater comprising a heating element, wherein at least a portion of the heating element is located within the cavity of the housing; a coupling assembly securing the heater within the housing; and a seal isolating the coupling assembly from direct contact with the heater.

In some implementations, the heater may have a side surface, wherein the coupling assembly comprises a main body dimensioned to engage with the housing and the side surface of the heater, the main body extending between the side surface and the housing. The seal may be secured on the main body of the coupling assembly with respect to the side surface and extend around the main body into a space between the housing and the side surface. The seal may comprise at least one laterally extending protrusion extending outwardly and in contact with the housing and the side surface. The seal may be removably coupled to the main body.

The main body may comprise a reinforcement element extending away from the main body substantially along the side surface into the space between the housing and the side surface, the reinforcement element being positioned substantially within the seal. The seal may comprise an outer sealing portion, an inner sealing portion and an upper sealing portion together forming a reinforcement cavity dimensioned to receive the reinforcement element. The seal may be secured on and over the reinforcement element. The outer sealing portion may seal the coupling assembly against the housing and the heater to substantially prevent water ingress into the space between the housing and the side surface. The inner sealing portion may isolate the heater from the main body of the coupling assembly.

The side surface may comprise a lateral protrusion extending into the space between the housing and the side surface, an underside of the lateral protrusion being in contact with the upper sealing portion to secure the seal on and over the reinforcement element, wherein the upper sealing portion isolates the main body from the side surface. The inner sealing portion and the outer sealing portion may be double-ribbed.

The main body may comprise at least one protrusion located on an outer peripheral surface of the main body to be coupled to at least one channel located on an inner surface of the housing to locate the coupling assembly within the housing.

According to another aspect of the present disclosure, there is provided a thermal immersion circulator, comprising: a heater having a side wall; a housing sized and dimensioned to receive at least a portion of the heater; a coupling assembly coupled to the housing, the coupling assembly comprising: a main body dimensioned to engage with the housing and the side wall of the heater to secure the heater with respect to the housing, the main body extending between the side wall and the housing thereby forming a cavity between the side wall and the housing and a reinforcement element; and a seal secured on the main body of the coupling assembly with respect to the side wall and the housing and extending around the main body and into the cavity, the seal comprising at least one laterally extending protrusion extending outwardly and in contact with the housing and the side wall; wherein the reinforcement element is positioned substantially within the seal to reinforce the seal.

According to a further aspect of the present disclosure there is provided a heater for a thermal immersion circulator, the heater comprising: a tubular side wall having longitudinal axis, a fluid inlet in communication with a fluid outlet, and a fluid heating portion located therebetween; at least one seal located adjacent the outlet; and a heating element physically coupled to the tubular side wall and wrapped at least partially about the fluid heating portion, the heating element comprising a plurality of resistive bands arranged on the tubular side wall, wherein a first portion of a resistive band of the plurality of resistive bands adjacent the fluid outlet is longitudinally spaced further from the fluid outlet compared to a longitudinal spacing between the outlet and an opposing second portion of the resistive band arranged on the side wall so as to reduce transfer of heat generated by the resistive band to the seal whilst heating the fluid substantially along a longitudinal length of the fluid heating portion.

Other aspects are also disclosed.

### BRIEF DESCRIPTION OF DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements, and may have been solely selected for ease of recognition in the drawings.

FIG. 1 illustrates a thermal immersion circulator according to at least one illustrated embodiment.

FIG. 2 is a cross-sectional view of the thermal immersion circulator as shown in FIG. 1, according to at least one illustrated embodiment.

FIG. 3 is an enlarged cross-sectional view of a cord support of the thermal immersion circulator as shown in FIG. 2, according to at least one illustrated embodiment.

FIG. 4 is a cross-sectional view of a housing of the thermal immersion circulator showing a cord supported by the cord support, according to at least one illustrated embodiment.

FIG. 5 is an exploded view of the thermal immersion circulator, according to at least one illustrated embodiment.

FIG. 6A is a perspective view of a heater coupled to a motor of the thermal immersion circulator, according to at least one illustrated embodiment.

FIG. 6B is an exploded view of the heater and the motor shown in FIG. 6A, according to at least one illustrated embodiment.

FIG. 7 is an enlarged cross-sectional view of a motor mount of the thermal immersion circulator, according to at least one illustrated embodiment.

FIG. 8 is a perspective view of a three-dimensional rendering of internal electronics and a motor seal of the thermal immersion circulator, according to at least one illustrated embodiment.

FIG. 9A is a perspective view of the heater of the thermal immersion circulator showing a flexible circuit wrapped around a side wall, according to at least one illustrated embodiment.

FIG. 9B is a front view of the heater of FIG. 9A showing the flexible circuit spaced from a fluid outlet opening, according to at least one illustrated embodiment.

FIG. 9C is a side view of the heater of FIG. 9A, showing a flange and a plurality of resistive bands of the flexible circuit spaced apart from a fluid bath temperature sensor located on the flange, according to at least one illustrated embodiment.

FIG. 10 is a plan view of the flexible circuit board shown in FIGS. 9A to 9C, according to at least one illustrated embodiment.

FIG. 11 is a perspective view of the heater showing resistive bands arranged in columns and spaced apart from the fluid bath temperature sensor, according to at least one illustrated embodiment.

FIG. 12 is an enlarged cross-sectional view of a lower inlet assembly and a coupling assembly securing the heater within the housing of the thermal immersion circulator, according to at least one illustrated embodiment.

FIG. 13 is an exploded view of the lower inlet assembly and the coupling assembly of FIG. 12, according to at least one illustrated embodiment.

FIG. 14A is a top perspective view of a seal shown in FIG. 13, according to at least one illustrated embodiment.

FIG. 14B is a bottom perspective view of the seal shown in FIG. 13, according to at least one illustrated embodiment.

FIG. 15 is a perspective view of the coupling assembly of FIG. 12 having the seal mounted thereon, according to at least one illustrated embodiment.

FIG. 16 is a perspective view of assembled internal components of the thermal immersion circulator, according to at least one illustrated embodiment.

### DESCRIPTION OF EMBODIMENTS

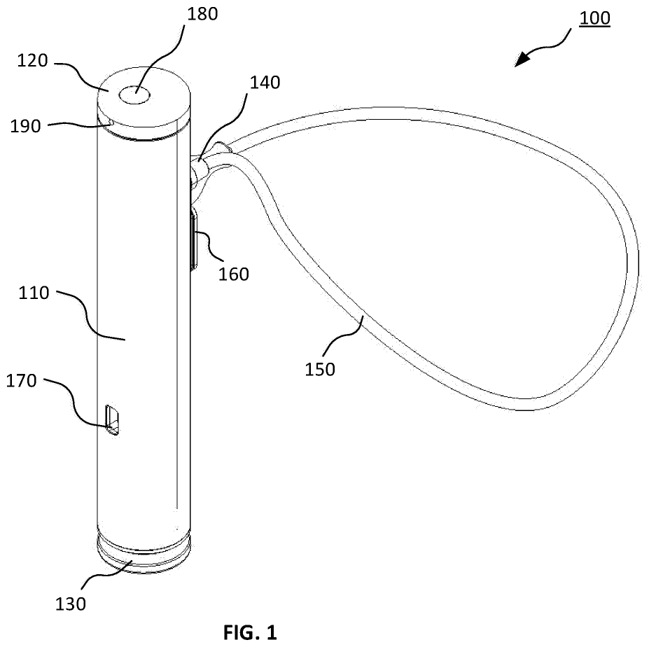

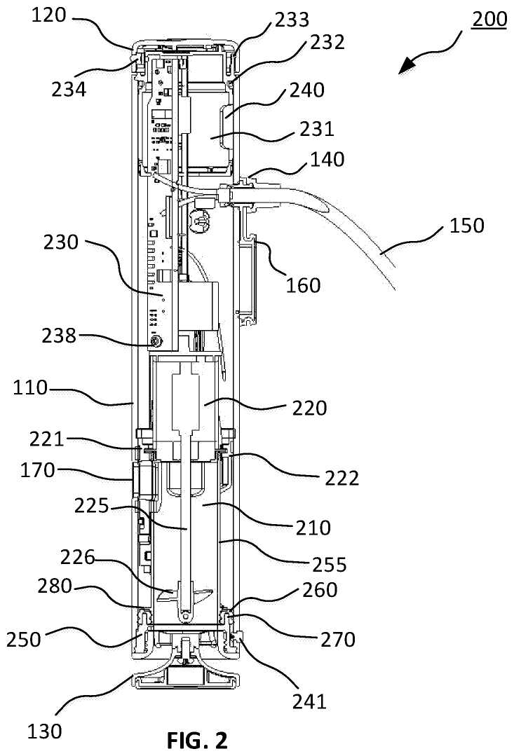

FIG. 1 shows a thermal immersion circulator 100. In one implementation, the thermal immersion circulator 100 comprises a housing, for example a waterproof housing 110, defining a cavity, a heater, for example a heater 210 shown in FIG. 2, a coupling assembly, for example a coupling assembly 250 shown in FIG. 2, securing the heater within the housing, and a seal, for example a seal 260, isolating the coupling assembly from direct contact with the heater. The heater may comprise a heating element, wherein at least a portion of the heating element is located within the cavity of the housing.

The thermal immersion circulator 100 can be positioned in a container, vessel, or pot (not shown). The container can hold a body of water or another fluid for cooking food, and the thermal immersion circulator 100 can be used to heat up, maintain a temperature of, or circulate the fluid within the container. The thermal immersion circulator 100 can be used for sous vide cooking. The thermal immersion circulator 100 can be positioned to stand upright in the container on a bottom end of the thermal immersion circulator 100, or can be clipped, clamped, or otherwise attached onto the rim or side of the container, as desired based on the size of the container, the depth of the fluid in the container, etc.

The waterproof housing 110 protects circuitry therein so the thermal immersion circulator 100 can be safely submerged, at least partially, in water or another fluid. The thermal immersion circulator 100 can also include a top cap 120, a lower inlet assembly 130, a cable mount assembly 140 for a power cord 150 and a cord support 160. The thermal immersion circulator 100 can also include a display, and relevant UI, etc. (not shown).

The lower inlet assembly 130 has a flat bottom surface on which the thermal immersion circulator 100 can stand. In some implementations, the flat bottom surface can include a magnet to help maintain the position of the thermal immersion circulator 100 within the container holding a body of water or another fluid for cooking food. The lower inlet assembly 130 can have a peripheral, radial opening through which a fluid can be drawn into an interior of the thermal immersion circulator 100.

The housing 110 may have a fluid outlet opening 170 to expel the fluid drawn into the interior of the thermal immersion circulator 100. Alternatively, the fluid can be expelled from the opening of the lower inlet assembly 130 of the thermal immersion circulator 100. The opening 170 can be formed in a side wall of the housing 110, through which a fluid can be drawn into, or through which a fluid can be expelled from, the interior of the thermal immersion circulator 100.

The top cap 120 is mounted to the housing 110 of the thermal immersion circulator 100. The top cap comprises a button 180 to turn on/off thermal immersion circulator 100 and a light indicator 190 to indicate whether the thermal immersion circulator 100 is turned on or off.

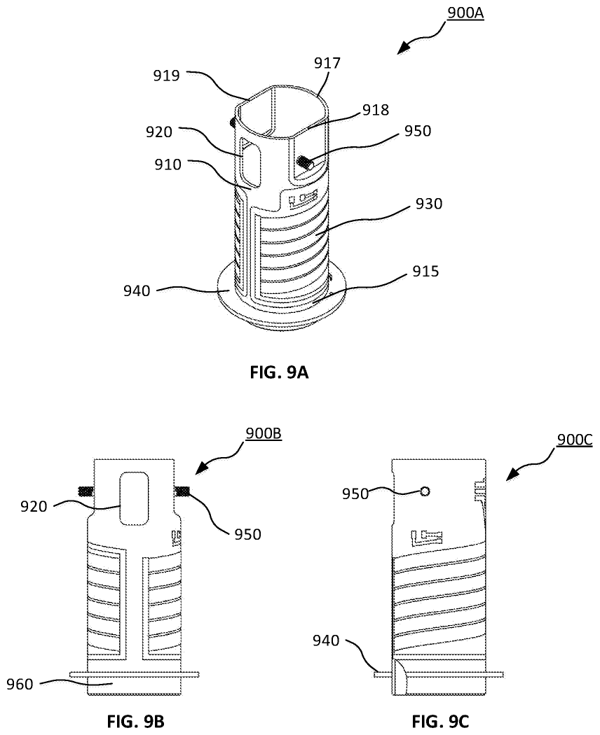

FIG. 2 shows the cross-sectional view 200 of the thermal immersion circulator 100 to illustrate various internal components of the thermal immersion circulator 100 according to some implementations of the present disclosure. The thermal immersion circulator 100 includes the heater 210. The heater 210 typically comprises one or more heating elements. In some implementations the heater 210 comprises one heating element in a form of a thermal coil. In alternative implementations, the heater 210 comprises a plurality of heating elements in a form resistive bands of a flexible printed circuit. The heater 210 is described in greater detail below with references to FIGS. 9 to 11.

A bottom end of the heater 210 is coupled to the lower inlet assembly 130 using the coupling assembly 250 so that an internal conduit or passage through the heater 210 is in fluid communication with the peripheral opening of the inlet assembly 130. The coupling assembly 250 is locked within the housing using an annular snap fit. A side surface 255 of the heater 210 can be coupled to the opening 170 so that the internal conduit through the heater 210 is in fluid communication with the opening 170, such as through an opening or slot in a side of the heater 210 and a passageway through a spacer, as described in greater detail below.

The coupling assembly 250 comprises a main body and a seal 260. The main body of the coupling assembly 250 is dimensioned to engage with the housing 110 and the side wall 255 of the heater 210 to secure the heater 210 with respect to the housing 110. The main body laterally extends between the side wall 255 and the housing 110 thereby forming a cavity between the side wall 255 and the housing 110. The seal 260 is secured on the main body with respect to the side wall 255 and the housing 110 and extends around the main body and into the formed cavity. The seal 260 can comprise at least one laterally extending protrusion extending outwardly and in contact with the housing 110 and the side wall 255.

The coupling assembly 250 can comprise a reinforcement element 270 which locates and ensures balanced compression of the seal 260 against the housing 110 and heater 210 to prevent water ingress. This arrangement of the reinforcement element with the seal 260 isolates the coupling assembly 250 from heater 210 ensuring the seal 260 compression is maintained even under abnormal heating conditions and thereby wholly or substantially preventing water ingress into the cavity within the housing 110. In this context, ‘substantially’ generally refers to situations where a small amount of fluid may get into the cavity, for example, between the seal 260 and the reinforcement element 270 or between the ribs of the seal, however, such a small amount of fluid is not considered to be in harmful quantities and does not affect electronic components of the thermal immersion circulator so that the thermal immersion circulator still meets the requirements of water immersion tests, such as IPX7. Specifically, IPX7 defines testing conditions, such as fluid temperature, fluid salinity, use of chemicals, test duration of 30 minutes and a depth of less than one meter.

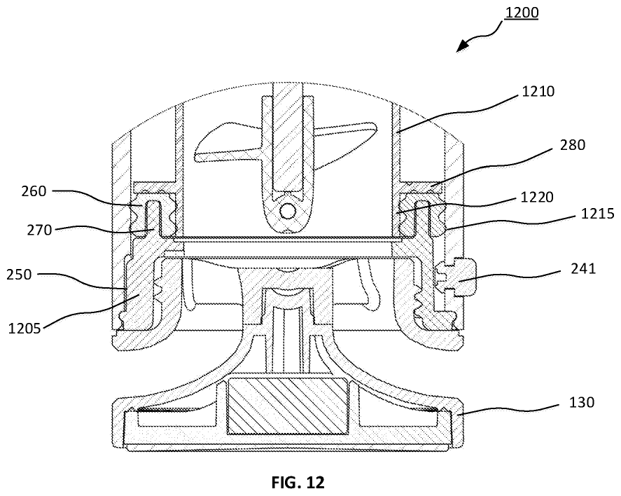

The reinforcement element, for example, can be integrally formed with the main body of the coupling assembly 250, such as a protrusion 270 extending vertically along the side wall (or side surface in case of a thermal coil) of the heater 210 into the cavity formed between the housing 110 and the side wall of the heater 210. Alternatively, the reinforcement element may be a separate element mounted within the seal 260. The seal 260 is dimensioned to be secured with respect to the main body of the coupling assembly 250 and to receive the reinforcement element 270. The seal 260 can be secured using different means, such as adhesive. The seal 260 is preferably removably mounted on the main body of the coupling assembly 250 and held is place using, for example, a lateral protrusion 280 extending outwardly from the side wall 255 of the heater 210. The seal 260 preferably tightly follows the contour of the side wall 255 and the housing 110. The seal 260 can be a radial seal. The coupling assembly 250 is described in further detail below with references to FIGS. 12 to 15.

The thermal immersion circulator 100 also includes a motor 220 coupled to the heater 210, a printed circuit board 230 controlling the heater 210 and the motor 220. The printed circuit board 230 can receive power from the cord 150 to control operation of the heater 210 and the motor 220.

The printed circuit board 230 is mounted within an electronics module mounting frame 231 as discussed below with references to FIG. 19. The PCB is also coupled to a motor frame using a nut 238. The motor 220 is discussed in detail below.

The electronics housing module comprises the top cap assembly 120 and the electronics module mounting frame 231. The mounting frame 231 comprises one or more seals 232, a lip 233 for securing the top cap assembly 120 on the housing 110, a light guide 234 and a communication module 240 to control the printed circuit board assembly 230. The communication module 240 can provide Wi-Fi or Bluetooth connection to control the PCBA 230.

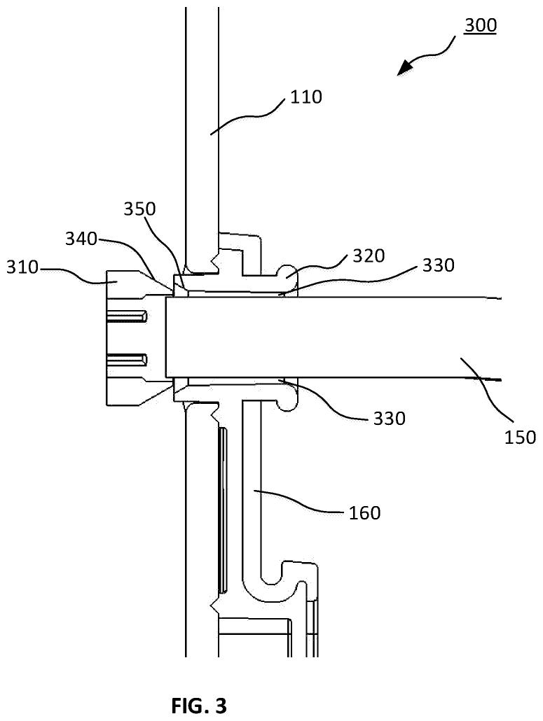

Additionally, the thermal immersion circulator 100 can also include a power cord 150 which can be used to plug the thermal immersion circulator 100 into a standard wall socket to draw power from a power grid. The power cord 150 can be mounted using the cable mount assembly 140 as discussed below with references to FIG. 3.

The motor 220 can be mounted to the top of the heater 210 using the front motor mount 221 and the rear motor mount 222. The front motor mount 221 and the rear motor mount 222 stabilise the motor 220 with respect to the rest of the thermal immersion circulator 100. In alternative embodiments, the motor 220 can be mounted to the top of the heater 210 in any suitable way, such as by any suitable mechanical fastener (e.g., a screw, bolt, nail, etc.) or any suitable adhesive (e.g., a glue, epoxy, etc.), or a friction or interference fit. The motor 220 can comprise a quiet 12V, 24V, or any other suitable voltage DC brushless, DC brush motor, switched reluctance motor, universal motor, or AC inductive motor. Various sealing elements, such as a compression surface gasket, can be used to seal the motor off from the fluid flowing through the heater 210, such as by preventing the fluid from escaping through mounting holes.

A shaft 225 can carry torque from the motor 220 to the impeller 226 to drive rotation of the impeller 226 and thus the flow of a fluid such as water through the interior of the heater 210. The impeller 226 can be mounted at or near the bottom of the main body of the heater 210, or closer to the bottom end of the main body of the heater 210 than to the fluid outlet opening 170, such that the heater 210 can be used in bodies of fluid having low fluid levels. The impeller 226 is installed within the interior of the heater 210. The impeller 226 can be a jet drive impeller. The impeller 226 can, for example, have two, three, or any other suitable number of blades and a central opening sized to receive the shaft 225 extending from the motor 220.

In one alternative implementation, the shaft 225 is not directly physically coupled to the motor 220. In such an alternative implementation, a first magnetic element is directly physically coupled to the motor 220, a second magnetic element is directly physically coupled to the shaft 225, and the first and second magnetic elements are magnetically coupled to one another. Thus, the motor 220 can be actuated to directly drive rotation of the first magnetic element, which can induce rotation of the second magnetic element via the magnetic coupling, and the rotation of the second magnetic element can induce rotation of the shaft 225 and the impeller 226. In such an alternative implementation, the shaft 225 and the impeller 226 are magnetically coupled to the motor 220. In another alternative implementation, the shaft 225 can be coupled to the motor 220, either physically or magnetically, via a gearbox or other intermediary components.

In use, the motor 220 can be turned on to drive the impeller 226, and can be used to control a rate of rotation of the impeller 226 to control the flow rate of a fluid such as water through the heater 210. In some implementations, and in particular when the heater 210 is being used to heat a fluid, the motor 220 can be used to drive the impeller 226 to rotate in a first direction, to cause fluid to flow upward, i.e., in through the opening at the bottom of the heater 210, through the interior of the main body of the heater 210, out of the main body through an opening in the tubular side wall 255 of the main body of the heater 210, and out of the housing 110 through the opening 170 in the side wall of housing 110.

By mounting the heater 210 in a thermal immersion circulator 100 and positioning the thermal immersion circulator in a fluid so that the bottom of the heater 210 is exposed to the fluid, the fluid (e.g., water) is allowed to be pulled into the heater 210 by the impeller 226 from the very bottom of the heater 210. Further, the motor 220 can drive the impeller 226 to rotate fast enough to draw water up through the interior of the main body of the heater 210 even when the water within the main body is exposed to atmospheric air, such as when the heater 210 is used to heat water having a very low water level (e.g., a water level below the bottom of the opening 170. As an example, a thermal immersion circulator 100 including the heater 210 can be used to heat a fluid having a depth of no less than 1.5 inches.

A fluid at a higher temperature rises above the same fluid at a lower temperature, so drawing the fluid into the heater 210 from the very bottom of the thermal immersion circulator 100 allows relatively cool fluid to be drawn into the heater 210, allowing more effective and efficient heating of the fluid. Further, drawing water in at the bottom of the heater 210 and upward through the main body helps to purge any air bubbles within the heater 210, and can help to reduce the level of noise generated by a thermal immersion circulator including the heater 210, such as by reducing cavitation within the heater 210. Further still, positioning the fluid outlet for the fluid flow in the side of the heater 210 rather than at the top end, and in the side of the housing 110, allows a thermal immersion circulator including the heater 210 to be more compact, as the motor 220 and other electric components of the thermal immersion circulator (e.g., a power source such as a battery or an electric cord for plugging into a wall outlet) can be mounted on top of the heater 210 within the housing 110.

FIG. 3 shows an enlarged cross-sectional view 300 of the cable mount assembly 140 for the power cord 150 and the cord support 160. The cable mount assembly 140 comprises a “cup and cone” arrangement comprising a connection element 310 coupled to a boss 320. The boss 320 is configured to receive the power cord 150. The power cord 150 is adhered to an internal surface of the boss 320 by injecting any suitable adhesive, such as glue, into the gap 330 to hold the power cord 150 in place.

The connection element 310 can be coupled to the boss 320 using a first tapered portion 340 dimensioned to engage a second tapered portion 350 of the boss 320 in mating engagement. The first tapered portion 340 is adapted to a) hold the cord 150 in place and b) cooperate with the second tapered portion 350 of the boss 320 during assembly to prevent the adhesive from flowing inside the electronics module. The first taper portion 340 cooperates with the second taper portion 350. The first taper portion 340 together with the second taper portion 350 forms a taper fit. The taper fit allows the first taper portion 340 (cone shape) to be inserted to the second taper portion 350 (cup shape) substantially without leaving a gap. Accordingly, the adhesive injected into the gap 330 forms a seal around the power cord 150.

As such, even if the gap 330 around the power cord 150 may be large, the liquid adhesive would still be able to form a seal due to the tight taper fit facilitated by the first taper portion 340 (cone shape) receiving the second taper portion 350 (cup shape). The tight taper fit, when assembled, effectively creates a landing zone for the liquid adhesive to bond with. In other words, a sealing surface area between the inner surface of the boss 320 and the power cord 150 is increased thereby preventing the adhesive leaking through and not forming a seal.

The above described sealing interface allows the power cord 150 to freely slide through during assembly. Additionally, the adhesive can be applied during the assembly to fill the sealing interface to seal around the power cord 150 to prevent water ingress. As such, the described configuration of the cable mount assembly 140 facilitates a loose interface between the power cord 150 and the cable mount assembly 140 during the assembly of the thermal immersion circulator 100 while preventing water ingress during use of the thermal immersion circulator 100.

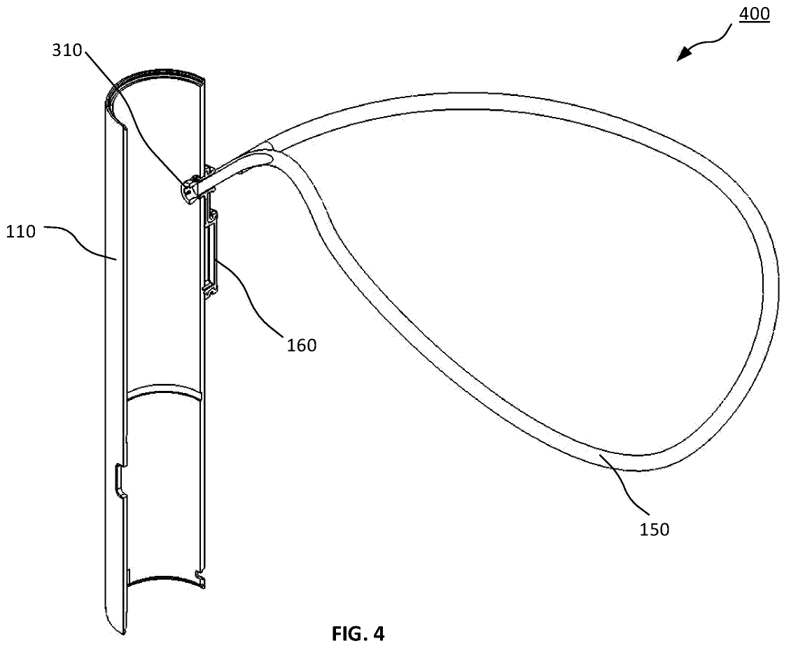

FIG. 4 shows a cross-sectional perspective view 400 of the housing 110 of the thermal immersion circulator 100 showing the cord 150 mounted using the connection element 310 and supported by the cord support 160.

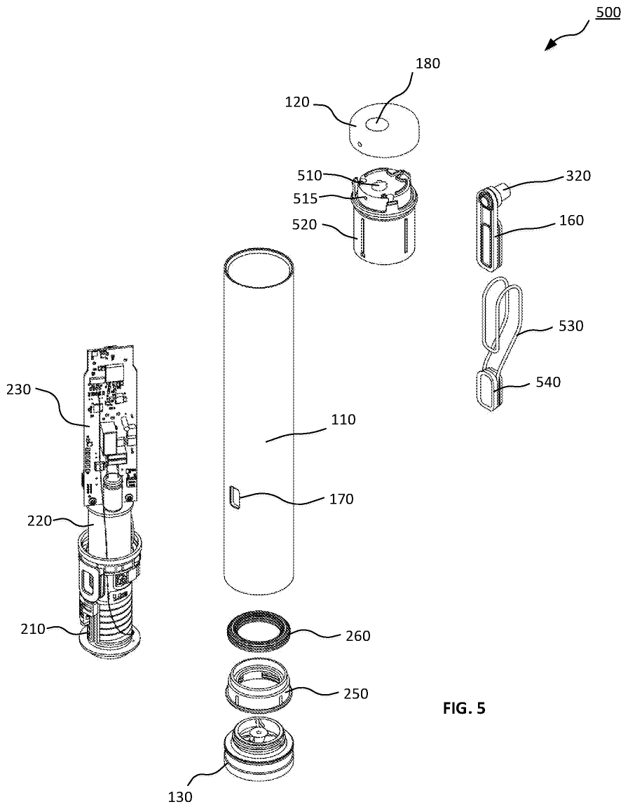

FIG. 5 shows the thermal immersion circulator 100 in an exploded view, and illustrates methods of assembling the thermal immersion circulator 100. For example, a method of assembling the thermal immersion circulator 100 can include, possibly, but not necessarily in the following order: coupling the heater 210 with the motor 220, coupling the motor with the electronics module 230, inserting the heater 210 coupled to the motor 220 and the electronics module including the electronics module housing into the housing 110 such that the fluid outlet opening 170 is aligned with an opening in the side wall 255 of the heater 210, then securing the heater 210 within the housing 110 using the coupling assembly 250 having a main body and a seal 260 mounted on the main body, then coupling the power cord 150 to the electronics module through the housing 110, then connecting and securing the top cap assembly 120 to the housing 110, then attaching the lower inlet assembly 130 to the housing 110, heater 210, and the coupling assembly 250, and then attaching the clip 530 having a molded pad 540 to the housing 110. The molded pad bears against a side of the container such that the side of the container can be clamped between the housing 110 and the pad 540 by a biasing action of the clip 530.

The clip 530 can include a wire (which can be stainless steel or any other suitable material) having a shape to mate with a groove in the cord support 160 to hold the clip 530 to the support 160 by friction, such as in an interference fit. Thus, the clip 530 can be easily removed from the support 160 and replaced with another clip, if desired, to suit dimensions of the container used for heating the fluid.

The method can further include coupling or joining the components inserted into the housing 110 to the housing 110 in a waterproof fashion, such as by ultrasonically welding, applying sealants or adhesives, or the use of mechanical seals. The components which can be coupled to or joined together with the housing 110 in a waterproof fashion may include the coupling assembly 250, the mounting frame 231, the bumper 241, the clip 530 and the power cord 150 and optionally the propeller to drive shaft.

For example, during first-time assembly or during inspection and/or servicing of the thermal immersion circulator 100, the radial seal 260 can be mounted onto the main body of the coupling assembly 250 to thereby isolate the coupling assembly 250 from direct contact with heating elements of the heater 210. The radial seal 260 may have two inner protrusions and two outer protrusions to position and secure the radial seal 260 against the housing 110 and the heater 210. The reinforcement element 270 can extend from the main body of the coupling assembly 250, and/or optionally be introduced into the radial seal 260 between the inner and outer protrusions to sealingly isolate the coupling assembly 250 from the heater 210.

The method can further include coupling the top cap assembly 120 to the top ends of a mounting frame 231 also shown as 520 and the housing 110. The method can further include coupling the propeller 226 to a drive shaft 225 coupled to the motor 220 and inserting the housing bumper 241 into a slot in the housing 110. The method can further include coupling the inlet assembly 130 to the bottom end of the housing 110. The method can further include attaching the clip 530 to the power cable 150.

The electronics module housing comprises the top cap assembly 120 and the mounting frame 520. The top cap assembly 120 comprises a first pressure sensitive adhesive sticker 510, a second pressure sensitive adhesive sticker 515 aligned with an opening in the top cap assembly 120, and a dome button 180.

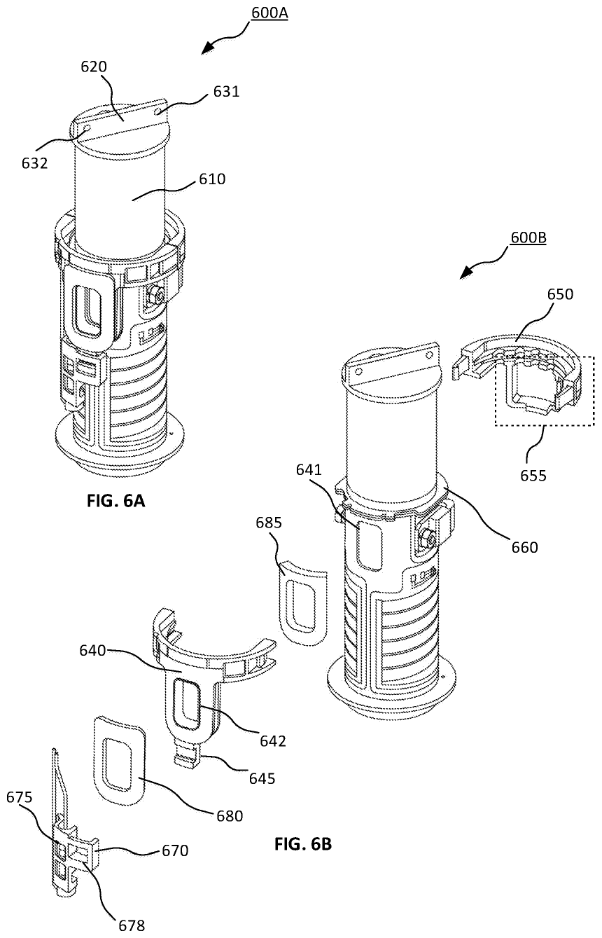

FIG. 6A is a perspective view 600A of an assembled configuration of the heater 210 coupled to the motor 220 of the thermal immersion circulator 100. The motor 220 is mounted on the heater 210 and comprises a motor housing 610. The motor housing 610 has a side wall, which can be substantially aligned with the side wall 255 of the heater 210, and a top end portion. The top end portion of the motor 220 comprises a vertically extending tab for securing the PCB 230 with respect to the motor housing 610. In one embodiment, the vertically extending tab 620 can have at least one opening to receive a screw or any other fastener for fastening the PCB 230 to the motor housing 610. As shown in FIG. 6A, the vertically extending tab, for example, can comprise two openings 631 and 632 adapted to receive screws or any other fastener for fastening the PCB 230 to the motor housing 610.

The printed circuit board 230 and electronics can be coupled to the ridge 620, such as with screws 238. The motor housing 610 can provide a heat path to transfer heat from above the motor 220 to below the motor 220. For example, heat from the printed circuit board 230 and electronics can flow through the ridge 620, through the top plate, through the outer shell, through the bottom plate, and into the fluid flowing through the heater 210 coupled to the bottom plate of the motor 220. To provide efficient flow paths, the top plate and the bottom plate of the motor 220 can comprise heat conductive materials such as zinc, copper, or aluminum, and the outer shell can comprise heat conductive materials such as zinc, copper, or aluminum. As two specific examples, the outer shell of the motor 220 can include a 1.65 mm thick copper shell or a 3.00 mm think aluminum shell.

FIG. 6B is an exploded view 600B of the heater 210 and the motor 220 shown in FIG. 6A. The motor housing 610 of the motor 220 is coupled with the heater 210. The motor mounts 640 and 650 are configured to stabilise the heater 210 and to maintain concentricity of the overall heater-motor assembly.

The motor mounts 640 and 650 can be positioned above the fluid outlet opening 170. The motor mounts 640 and 650 can be similar to the front motor mount 221 and the rear motor mount 222. Additionally, the motor mount 640 comprises a fluid outlet portion extending around an opening 641 in the side wall 255 of the heater 220. The fluid outlet opening 641 is aligned with the fluid outlet opening 170 to enable fluid communication between the opening 641 and the fluid outlet opening 170, i.e. between fluid being heated and the heater 210.

The fluid outlet portion comprises an opening 642 substantially coinciding with the fluid outlet opening 641 of the side wall 255 of the heater 210 and a lip 645 for coupling with a thermal fuse holder 670. The thermal fuse holder 670 comprises an opening 675 dimensioned to receive a thermal fuse of the heater 210 and an opening 678 dimensioned to receive the lip 645. The thermal fuse holder 670 is coupled with the front motor mount 640 by locking the opening 687 with respect to the lip 645 in a locking engagement. For example, the lip 645 can have a protrusion so that when the thermal fuse holder 670 is being coupled to the front motor mount 640, the protrusion engages the opening 678 thus securing the thermal fuse holder 670 with respect to the front motor mount 640 in the locking engagement.

The thermal immersion circulator 100 also comprises a first foam seal 680 and a second foam seal 685 to substantially prevent water ingress into the electronics module. The fluid outlet portion and the foam seals 680 and 685 together forming a spacer having a passageway positioned in between the openings 170 and 641. The passageway has a shape matching that of the openings 170 and 641, such that the openings 170 and 641 and the passageway can form a single channel that can carry water or other fluids from within the interior of the heater 210 out of and away from the heater 210 and the electrical components of the heater 210.

The front motor mount 640 is effectively sandwiched between the foam seals 680 and 685. The motor mount 640, the fluid outlet opening 170, the foams seals 680 and 685, and the opening 641 are configured to form a passageway for fluid to and from the heater 210, in particular, for heated fluid to be expelled from the inside of the heater 210. The rear motor mount 650 comprises the extended portion 655 counterbalancing the reactive forces of the foam seals 680 and 685 to substantially prevent dislocation of the motor 220 with respect to the heater 210 and/or the housing 110 even during abnormal heating condition.

The motor mounts 640 and 650 and the coupling assembly 250 are made from a higher heat reflection material, such as Polyetherimide (PEI) plastic, to reduce warpage of the surfaces of the seals, such as foam seals 680 and 685 and radial seal 260.

The motor mounts 640 and 650 are configured to receive and engage with a bottom plate 660 of the motor housing 610. For example, each of the motor mounts 640 and 650 can have a slot for receiving and securing the bottom plate 660 of the motor housing 610 with respect to the rest of the thermal immersion circulator 100.

The rear motor mount 650 comprises an extended portion 655 extending in the same direction as the fluid outlet portion. The extended portion 655 stabilises the motor 220 and the heater 210 and also counteracts potential misalignment of the motor 220 and the heater 210 caused by the foam seals 680 and 685, which squeeze the heater 210 and the motor 220 to provide sealing. The above discussed counteracting mechanism of the extended portion 655 substantially prevents water ingress to the electronics module, such as PCBA 230. The extended portion 655 of the rear motor mount 650 effectively balances the reaction forces caused by the foam seals 680 and 685 to centralise the heater 210 and the motor 220. The discussed arrangement of the heater 210, motor 220 and the motor mounts 640 and 650 substantially prevents water ingress into the electronics module 230 particularly under abnormal heating conditions.

For the purposes of this disclosure, the abnormal heating conditions refer to an out of control heating event or thermal fuse abnormal testing, such as IPX7 testing. When the out of control heating event occurs, parts around the heater 210 are exposed to temperatures in excess of 400° C. during a thermal fuse abnormal test. The above described arrangement the front motor mount 640 and the rear motor mount 650 substantially prevent distortion of plastic parts such that foam seals 680 and 685 and balances the reaction forces caused by the foam seals 680 and 685 to centralise the heater 210 and the motor 220 to enable the thermal immersion circulator 100 to meet IPX7 requirements and thus maintaining IPX7 protection.

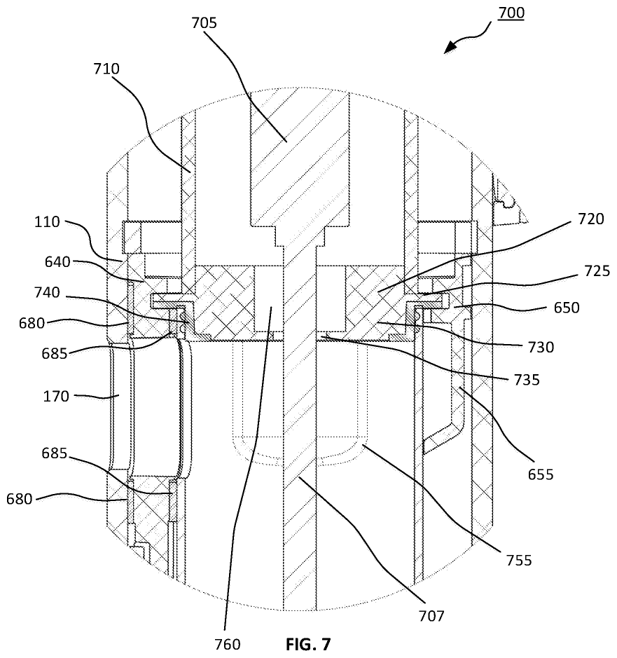

FIG. 7 shows and enlarged cross-sectional view 700 of the motor mount of the thermal immersion circulator 100.

The motor 220 comprises a motor engine 705, a shaft 707 mounted within the motor engine 705 and driven by the motor 220 to carry torque from the motor 220 to the impeller 226, an outer cylindrical shell 710 surrounding the motor engine 705, and a bottom plate 720 isolating the motor engine 705 from the heater 210. The outer cylindrical shell 710 together with the bottom plate 720 form a motor housing. The cylindrical shell 710 may have a side flat wall 755.

Mechanical or electrical components of the motor 220 can be housed within the shell 710 between a top plate shown in FIG. 6A and the bottom plate 720, and can be used to turn a drive shaft 707, having a diameter of about 4 mm, such as at rates of at least 1800 rpm, with 2600 rpm being a suitable example.

The bottom plate 720 is attached at the bottom of the outer cylindrical shell 710 adjacent to the heater 210 to substantially enclose the motor engine 705 and prevent water ingress from inside the heater 210. The bottom plate 720 is dimensioned to tightly fit within the outer cylindrical shell 710. In alternative configurations, the bottom plate can be integrally formed with the outer cylindrical shell 710. The bottom plate 720 comprises a lateral protrusion, such as a flange 725, securing the bottom plate 720 with respect to the outer cylindrical shell 710. The flange 725 extends outwardly around the outer cylindrical shell 710 as shown in FIG. 6B to secure the motor mounts 640 and 650 within the housing 110 and with respect to the heater 210.

The bottom plate 720 also comprises an extended portion extending vertically away from the flange 725, such as a boss 730, a seal 735 sealing an opening in the bottom plate 720 and the boss 730 to allow movement of the shaft 707 while preventing water ingress from the inside of the heater 210. The boss 730 is dimensioned to fit within an internal surface of the heater 210. The boss 730 can have a cross sectional shape matching the cross-sectional shape of the interior of the top portion of the heater 210, so that the boss 730 can snugly mate with the interior of the top portion of heater 210 while the flange 725 engages the top of the heater 210.

Additionally, the bottom plate 720 comprises a seal 740 positioned to extend around the boss 730 where the boss 730 meets the flange 725. The seal 740 seals around the peripheral of the boss 730 and underneath the flange 725 to prevent water ingress from inside of the heater 210 and through coupling of the internal wall of the heater 210 with the motor 220. The seal 740 is preferably a double-ribbed seal. The bottom plate 720 also comprises an opening 760.

The bottom plate 720 can separate the hollow interior of the heater 210 from an interior of the thermal immersion circulator 100 above the heater 210. The peripheral surface of the hole 760 can be smooth, and the hole 760 can be configured to allow a rotor or drive shaft 707 to pass from the exterior, through the bottom plate 720, and into the interior of the heater 210.

The front motor mount 640 and 650 comprise a slot for receiving the flange 725 and the seal 740 extending underneath the flange 725 to secure the motor mounts 640 and 650 in place with respect to the outer cylindrical shell 710.

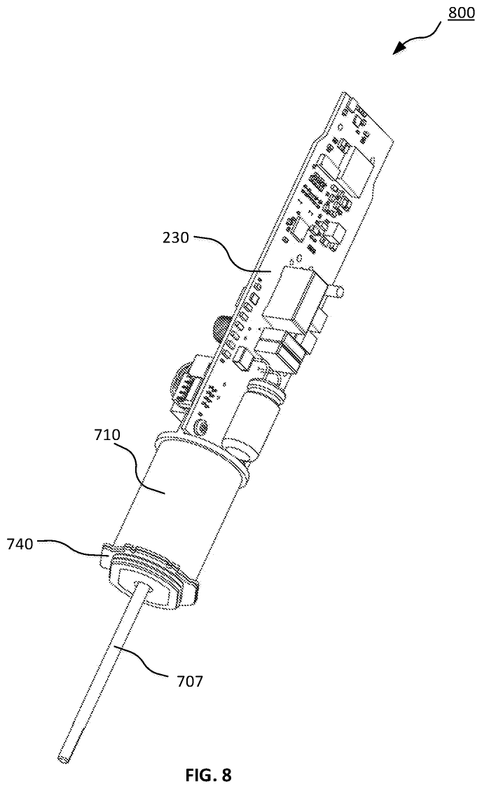

FIG. 8 shows a three-dimensional rendering of internal electronics and the motor 220 of the thermal immersion circulator 100. As shown in FIG. 8, the double-ribbed reinforced seal 740 substantially following the contour of the flange 725 to provide a tight fit between the side wall 255 of the heater 210 and the bottom plate 720. It is noted that use the double-ribbed reinforced seal 740 between the motor housing and the heater 210 provides seal redundancy and further prevents water ingress into internal electronics module. FIG. 8 also shows that the PCBA 230 is coupled with the motor using screws 238 or other fasteners and openings 631 and 632. Alternative types of coupling are also possible.

FIG. 9A shows the heater 210 that can be used in a thermal immersion circulator such as the thermal immersion circulator 100. The heater 210 includes a hollow, substantially cylindrical, main body 910 having a tubular side wall and an annular cross-sectional shape, and a radial flange, foot, or ridge 940 coupled to a bottom end portion of the main body 910. The tubular side wall has a longitudinal axis and a fluid inlet in communication with a fluid outlet. A fluid heating portion of the heater 210 is located between the fluid inlet and the fluid outlet.

In alternative embodiments, the main body 910 can have a generally circular, elliptical, rectangular, square, triangular, or other suitable cross-sectional shape. The main body 910 and the flange 940 can be formed from a single, integral, unitary piece of material, or they can be formed from separate pieces of material coupled to one another by any of various known techniques. In other embodiments, the heater 210 can be fabricated without the flange 940.

The main body 910 and the flange 940 can be formed from any of various suitable materials, such as any suitable metal (e.g., polished stainless steel, copper, or aluminum), plastic (e.g., thermosetting plastics), ceramic, porcelain, etc., and these components can be made from the same material(s) or from different materials as one another. The main body 910 and the flange 940 can also be coated with non-stick materials. The materials can be electrically conductive or non-electrically conductive, heat-conductive or non-heat-conductive, and have sufficient strength and temperature tolerances to provide the heater 210 with rigidity and structure at temperatures across the intended working range of the heater 210. Use of metallic materials such as stainless steel provides the heater 210 with very smooth surfaces and allows the heater 210 to be easily and rapidly cleaned.

The main body 910 includes a hollow cylindrical bottom portion 915 having an interior surface and an exterior surface (not shown) each having a circular cross-sectional shape. The main body 910 also includes a top portion 917 that is substantially cylindrical and has a first, left side flat wall 918 and a second, right side flat wall 919. The left side wall 918 is positioned opposite to the right side wall 919 across the top portion 917 of the main body 910, such that the left side wall 918 is parallel to the right side wall 919. The top portion 917 is hollow and has an interior surface and an exterior surface each having circular cross-sectional shapes truncated by the left side wall 918 and by the right side wall 919.

A pair of protrusions such as threaded studs 950 can be coupled to and/or extend from the top portion 917 of the main body 910. For example, a first threaded stud can extend radially away from and perpendicular to the left side wall 918, and a second threaded stud can extend radially away from and perpendicular to the right side wall 919. The threaded studs 950 can include solid cylindrical protrusions having threads on an exterior surface thereof.

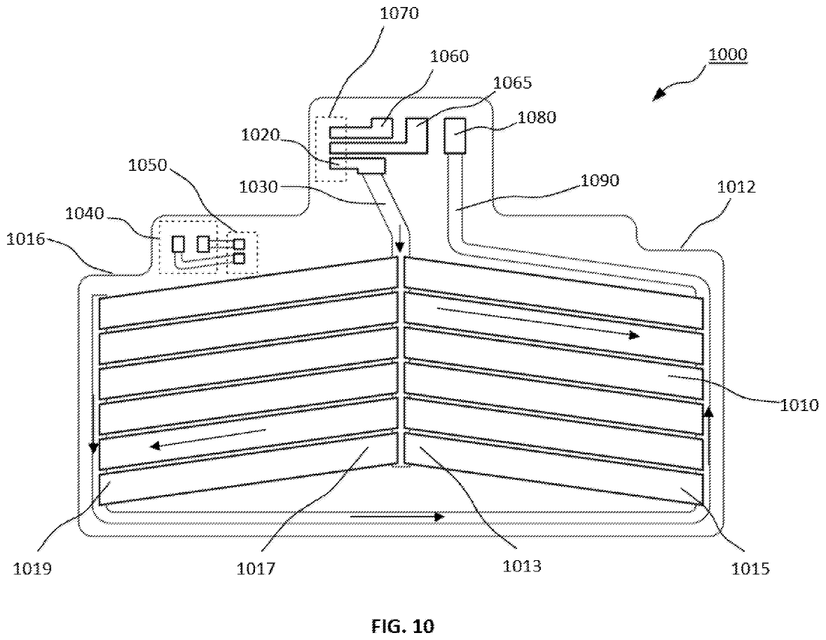

Further, the heater 210 comprises a flexible circuit board 930. The flexible circuit board 930 comprises a heating element physically coupled to the tubular side wall and wrapped at least partially about the fluid heating portion. The flexible circuit board 930 is coupled to the exterior surface of the main body 910, including to the exterior surface of the bottom portion 915 and to the exterior surface of the top portion 917 of the main body 910. The flexible circuit board 930 is a thick-film flexible circuit board 930, as described in greater detail below with references to FIG. 10. Alternatively, other implementations can use a thin-film flexible circuit board, a thin-film resistive heater, a thick-film resistive heater, a wire-wrapped heater, a flexible polyamide, or other similar technologies, instead.

The heating element comprises a plurality of resistive bands arranged on the tubular side wall spaced apart from the fluid outlet opening 920 at least by a predetermined distance and occupying substantially an entire fluid heating portion. The plurality of resistive bands collectively forms a heating surface of the flexible circuit board 930. The distance between the heating surface and the fluid outlet opening 920 may be 11 mm.

The heating surface can have a rectangular or a non-rectangular shape. The heating surface is spaced from the fluid outlet so as to reduce transfer of heat generated by the plurality of resistive bands to the foam seals 680 and 685 located adjacent the outlet while occupying substantially the entire fluid heating portion. A first portion of a resistive band adjacent the fluid outlet is longitudinally spaced further from the fluid outlet compared to a longitudinal spacing between the fluid outlet and a horizontally opposing second portion of the resistive band. In other words, a proximal end of a transversely extending resistive band is longitudinally spaced further away from the fluid outlet than a distal end of the transversely extending resistive band. By spacing the proximal end of the resistive band further away from the fluid outlet opening compared to the distal end, it is possible to achieve reduction in transfer of heat generated by the resistive band whilst heating the fluid substantially along a longitudinal length of the fluid heating portion.

In a specific form as shown in FIG. 9C, the first portion is a portion of the top resistive band which is located on the left side of tubular structure and the second portion of the top resistive band is located on the opposing right side of the tubular structure and higher relative to the first portion. In this example, the first portion and second portion of the resistive band are located on opposing or diametrically opposing surfaces of the tubular structure. In this arrangement, the first portion is of the top band is spaced longitudinally from the outlet to reduce damage to the seals 680, 685. The longitudinal spacing between the top heating element and the outlet may vary and can be about 4.1 mm or more. However, the second portion of the top band extends further along the longitudinal axis of the tubular structure relative to the first portion of the top band such that the heating element extends substantially the length of the fluid heating portion. This second portion of the top band which extends past the first portion of the top band along the longitudinal axis contributes toward additional heating efficiency by heating the fluid toward the upper end of the tubular structure but on an opposing side of the tubular structure relative to the fluid outlet.

For the purposes of this description, longitudinal spacing refers to spacing or a distance along the longitudinal axis of the tubular side wall. For example, a longitudinal distance between a portion of a resistive band and the fluid outlet opening refers to a distance between a projection of the portion of the resistive band onto the longitudinal axis of the tubular side wall and a projection of the fluid outlet onto the longitudinal axis of the tubular side wall.

The plurality of resistive bands can be diagonally arranged on the side wall of the heater 210 such that a longitudinal distance between a top end portion of the heating surface and the fluid outlet varies along the circumference of the tubular side wall. The top end portion of the heating surface refers to an end portion of the heating surface longitudinally adjacent to the fluid outlet. Such a diagonal arrangement of the resistive bands allows the heating surface to occupy substantially an entire fluid heating portion while being spaced from a seal located about the fluid outlet. The plurality of resistive bands can be arranged on the side wall of the heater in at least two columns of resistive bands, each column comprises at least one bottom resistive band adjacent to the fluid inlet and at least one top resistive band adjacent to the fluid outlet. For example, resistive bands in at least one column can form an oblique angle with a top end portion of the fluid heating portion to increase packing density of the resistive bands. As such, a distance between each top resistive band and the top end portion can vary along the column to occupy substantially an entire fluid heating portion while being spaced apart from the fluid outlet opening. Arrangement of the flexible circuit board 930 is described in more detail below with references to FIGS. 9B, 9C and 10 to 11.

The radial flange 940 has an annular shape, with an outer diameter of the flange 940 being greater than an outer diameter of the main body 910. In some implementations, an inner diameter of the flange 940 can match an inner diameter of the main body 910, such that the flange 940 can be coupled to a bottom end of the main body 910, leaving an interior of the main body 910 flush with an interior surface of the flange 940. In other implementations, the inner diameter of the flange 940 can match the outer diameter of the main body 910, such that the flange 940 can be coupled to the exterior surface of the bottom portion 915 of the main body 910 at a bottom end thereof. The flange 940 can be formed from a single flat plate of material, such as by cutting a circular opening in a flat circular piece of material. In some embodiments, the flange 940 can be made of stainless steel or polished stainless steel. Alternatively, the flange 940 can be made of copper, aluminium, plastic (e.g., thermosetting plastics), ceramic, porcelain, etc.

Thus, the flange 940 can have a rectangular cross-sectional shape along a vertical plane. The flange 940 can form one part of a seal between the heater 210 and another component of a thermal immersion circulator 100 of which the heater 210 is a part. In some implementations, the main body 910 and the radial flange 940 can be formed unitarily, such as in a single molding process, such as in a single metal injection molding process.

The main body 910 also comprises an oblong opening 920 positioned at the front portion of the main body 910 such that the opening 920 is spaced equidistantly from the left side wall 918 and the right side wall 919. The heater 210 is preferably symmetrical about the opening 920. The opening 920 can have a generally rectangular shape having an aspect ratio between a horizontal axis and a vertical axis ranging from about 3:1 to 1:3 to provide more space between the seals 680, 685 and heating tracks or resistive bands of the flexible circuit board 930. The aspect ratio may vary based on design requirements. The opening 920 is positioned closer to the top end of the main body 910 than to the bottom end of the main body 910. In alternative implementations, the opening 920 can have any other suitable shape a person skilled in the art could design.

A top end of the opening 920 can be co-planar with the bottom surface of the boss 730 of the bottom plate 720. Thus, any bubbles entering or formed within the interior of the main body 910 can flow out of the interior of the main body 910 and out of the circulator 100, thereby reducing deleterious effects of air or other gaseous build-up in the interior of the main body.

When the heater 210 is in use, an opening at the bottom of the main body 910 can be an inlet to the heater 210, the opening 920 can be an outlet of the heater 210, and the interior of the heater 210 can be a conduit, passage, or channel in fluid communication with the inlet and the outlet. As described further below, a thick film flexible circuit board 930 can be wrapped around an external surface of the main body 910 between the inlet and the outlet, and thus can be wrapped around the conduit that fluidly couples the inlet to the outlet.

The inlet and the outlet can be separated by the flexible circuit board 930 and the flexible circuit board 930 can be positioned to heat fluid passing between the inlet and the outlet. A fluid flow path through the heater 210 can extend from the inlet, through the conduit past the flexible circuit board 930, to the outlet. The flexible circuit board 930 can be separated from the fluid passing through the interior of the main body 910 by a distance corresponding to the thickness of the tubular side wall of the main body 910, which can be 0.5 mm, 1.0 mm, 1.5 mm, 2 mm, 2.5 mm, between 0.1 mm and 5 mm, or between 0.5 mm and 2.5 mm.

When the heater 210 is in use, a significant current can pass through controlling electronics (e.g., the TRIACs) and the other electrical components of the flexible circuit board 930. For example, using a 120V AC, 60 Hz power supply, the heater 210 can draw 1100±100 W of power total. Such a large power draw can heat the controlling electronics (e.g., the TRIACs), in some cases, to undesirably high temperatures.

In the heater 210, the controlling electronics (e.g., the TRIACs or any suitable electronic switch either enclosed within an encapsulant or an encapsulating package, or not encapsulated and built integrally with the main body 910) are mounted in direct contact with a surface of the main body 910, which can comprise a highly heat-conductive material such as steel, and which is in direct contact with the flexible circuit board 930. That is, the controlling electronics (e.g., the TRIACs) and the flexible circuit board 930 can be in direct contact with a common heat conductive surface. The term “direct contact,” in this context, includes contact through one or more substrate layers, such as an adhesive layer, a fill pad, a thermally conductive film, or a grease. A fluid (e.g., water) drawn through the heater 210 can act as a coolant for the controlling electronics (e.g., the TRIACs) to draw heat conducted from the controlling electronics through the main body 910 away from the controlling electronics. Thus, the controlling electronics (e.g., the TRIACs) can be water-cooled. Substantially all of the heat generated by the TRIACs can be transferred into the fluid being heated, such that a temperature of the TRIACs can be substantially the same as the temperature of the fluid being heated. This heat exchange pathway simultaneously transfers heat away from components that benefit from cooling, and into the fluid that is to be heated. Thus, the heating element, i.e. resistive bands of the flexible circuit board 930, as well as the controlling electronics, can be thermally coupled or thermally conductively coupled to the fluid passing through the main body 910.

In some embodiments, the interior surface of the heater 210 can be textured or texturized to retain some of the fluid being heated (e.g., some of the fluid can cling to the textured surfaces by surface tension) when the thermal immersion circulator 100 and the heater 210 are removed from the body of the fluid being heated. For example, the interior surfaces of the heater 210 can be texturized so they are hydrophilic. Alternatively, the interior surfaces can also be coated with a hydrophilic coating to improve the retention of a fluid such as water by the interior surfaces when the heater 210 is removed from the body of the fluid. Water or any other fluid retained on the interior surfaces can provide a heat reservoir to protect the thermal immersion circulator 100 and the heater 210 from transient thermal effects arising from the removal of the circulator 100 and heater 210 from the body of the fluid being heated, such as by removing heat from the heater 210 through latent heat of vaporization of the fluid.

In some embodiments, the heater 210 includes one or more temperature responsive transducers, e.g., thermistors, thermocouples, resistance temperature detectors (RTD), etc. As one specific example, the heater 210 can include two thermistors: a first thermistor near the bottom of the main body 910, such as on the flange 940 and a second thermistor at the flexible circuit board 930. Optionally, the heater 210 can comprise a third thermistor near the slot 920.

The first and third thermistors can provide information regarding the temperature of the fluid being heated to facilitate more precise control of the heater 210. The second thermistor can provide information regarding the temperature of the heating element to facilitate the prevention of their overheating.

A thermal immersion circulator including the heater 210 can include control circuitry or a computer that can direct the operation of the flexible circuit board 930, such as through the TRIACs. As one example, the control circuitry or computer can accept a desired or target temperature of a fluid to be heated, such as a temperature designated by a user of the thermal immersion circulator. The control circuitry or computer can direct the TRIACs to switch both the heating elements on, and can direct the motor 220 to turn the impeller 226. The heating elements can generate heat that is conducted through the main body 910 to the fluid being heated within the interior of the main body 910. Once the temperature of the fluid being heated, as measured by the first thermistor or the third thermistor, reaches the target temperature, the control circuitry or the computer can direct the TRIACs to switch the heating element off. The TRIACs receive power from the PCBA 230 and in turn power the fuse 675.

To maintain the fluid at the target temperature, the control circuitry or the computer can direct the TRIACs to intermittently switch on one of the heating elements. In some implementations, the control circuitry or the computer can direct the TRIAC to switch the heating element on and off at pre-determined time intervals. In other implementations, the control circuitry or the computer can direct the TRIAC to switch the heating element on when the temperature of the fluid being heated, as measured by the first thermistor or the third thermistor, falls below the target temperature by a pre-determined amount, and off when the temperature of the fluid being heated, as measured by the first thermistor or the third thermistor, rises above the target temperature by a pre-determined amount.

As another example, if the temperature of one of the heating elements, as measured by the second thermistor, exceeds a threshold temperature, such as a temperature at which the flexible circuit board 930 might suffer damage, then the control circuitry or computer can direct the TRIACs to switch the heating elements off.

FIGS. 9B and 9C are illustrations of front and left-side views, respectively, of the heater 210.

FIG. 9B shows that the transitions between the bottom portion 915 and the left side wall 918 and right side wall 919 of the top portion 917 of the main body 910 are curved. FIG. 9B also shows that the opening 920 extends through a front portion of the tubular side wall of the main body 910, that is, through a curved front portion of the tubular side wall of the cylindrical main body 910.

FIG. 9B also shows that, when the heating element is wrapped about the tubular side wall of the heater 210, the left hand side and right hand side of the heating element are arranged spaced apart from each other so that ‘hot spots’ formed by the resistive bands are positioned away from the opening 920 and the fluid outlet seals 680 and 685 to prevent deformation of the foam seals 680 and 685 even under abnormal heating conditions. The resistive bands are preferably spaced apart from each other substantially symmetrically about the vertical axis of the opening 920 to form a column free from heating elements below the opening 920 and coinciding with the vertical axis of the opening 920.

Additionally, as shown in FIG. 9B, a distance between a bottom end portion of lower resistive bands and the flange or the bottom end portion of the heater varies.

The heater 210 also comprises a boss 960 downwardly extending from the flange 940. An internal diameter of the boss 960 can match the internal diameter of the bottom end portion of the main body 910 and an external diameter of the boss 960 can match the external diameter of the bottom end portion of the main body 910 such that the boss 960 flush with the main body 910. The boss 960 can be integrally formed with the side wall of the heater or alternatively be a separate component.

FIG. 9C shows an arrangement of resistive bands in one column of the heating element. In particular, rather than being horizontally arranged, the resistive bands are diagonally arranged as shown in FIG. 9C to increase packing density while allowing the resistive bands to be spaced apart from the fluid outlet opening 920 and foam seal 680 and 685 thus substantially preventing seal deformation even under abnormal heating conditions.

The diagonal arrangement of resistive bands also allows the fluid bath temperature to be more accurately measured since a distance from a fluid bath temperature sensor coupled to the heater and typically located on the flange 940 is increased. Specifically, according to the present disclosure, a resistive band adjacent to the fluid inlet is spaced at least by a predetermined distance, preferably by at least 10 mm, from the fluid bath temperature sensor. The predetermined distance may vary based on design requirement. Such spacing reduces interference of heat generated during operation of the heating element when measuring a temperature of the fluid entering the fluid inlet or heater by the fluid bath temperature sensor. Alternative arrangements of the resistive bands are also possible as long as the predetermined distance from the seals 685 is maintained. For example, the resistive bands can be vertically arranged.

FIG. 10 shows a plan view of a layout of the printed circuit board 930.

The printed circuit board 930 is arranged on the exterior surface of the main body 910 of the heater tube so that ‘hot spots’ are positioned away from the seals 680 and 685. For the purposes of present disclosure, ‘hot spots’ refer to the heat or temperature of about 400° C. or higher generated by resistive bands. The described arrangement of the resistive bands allows ‘hot spots’ to be positioned away from the fluid outlet and seals 680 and 685 to prevent deformation of seals and plastic parts of the fluid outlet.

Additionally, a distance between a first end of the bottom two resistive bands and the bottom end portion of the heater 210 is increased to enhance the accuracy of fluid bath temperature sensor readings located at an upper surface of the flange 940. The distance is preferably equal to or larger than 10 mm to ensure the accuracy of the readings of the fluid bath temperature sensor. The distance may vary based on design requirements.

The printed circuit board can be a thick-film printed circuit board 1000. In alternative arrangements, the printed circuit board can be a thin-film flexible circuit board, a thin-film resistive heater, a thick-film resistive heater, a wire-wrapped heater, a flexible polyamide, or other similar technologies, instead.

The thick-film printed circuit board 1000 can include a plurality of resistive bands or heater tracks 1010. For example, as illustrated in FIG. 10, the circuit board 1000 can have 12 resistive bands. The plurality of resistive bands 1010 can draw 1100 W of power total. Each of the resistive bands 1010 can include a thick film band formed on the base layer from any suitable resistive material. For example, the resistive bands 1010 can comprise an FeCrAl alloy, such as the commercially available FeCrAl alloy sold under the brand name Kanthal®. For example, a resistive paste can be laid down on the base layer, and a width and a thickness of the paste can be carefully controlled to provide each resistive bands 1010 with a well-defined resistance.

The thick-film printed circuit board 1000 comprises two portions 1012 and 1016 adjacent to the fluid outlet openings 170 and 920. The plurality of resistive bands 1010 can be arranged on the thick-film printed circuit 1000 in at least two adjacently located and electrically coupled columns. The resistive bands in each column are arranged diagonally and substantially in parallel to each other such that resistive bands in each column have a fluid inlet end and a fluid outlet end.

Each column of the resistive bands comprises at least one bottom resistive band adjacent to a bottom end portion of a fluid heating portion of the thick-film printed circuit board 1000 and at least one top resistive band adjacent to a top end portion of the fluid heating portion. A distance between each top resistive band and the top end portion varies along the at least two columns to occupy substantially an entire fluid heating portion while being spaced apart from the fluid outlet openings 170 and 920. The plurality of resistive bands 1010 is spaced apart from the fluid bath temperature sensor at least by a predetermined distance. The predetermined distance can be at least 10 mm or more. The distance may vary based on design requirements. A distance between each bottom resistive band and the bottom end portion varies along the at least two columns to enhance accuracy of temperature sensor readings. The resistive bands 1010 are effectively arranged in a zig-zag manner, however, other arrangements of resistive bands where the resistive bands are spaced apart from the fluid outlet openings 170 and 920 at least by the predetermined distance are also possible. It should be noted that the resistive bands 1010 preferably have substantially the same area and/or perimeter.

For example, as shown in FIG. 10, resistive bands in a first column adjacent to 1012 can have a first (upper) end 1013 in proximity to the fluid bath temperature sensor and a second (lower) end 1015 in proximity to the longitudinal axis of the fluid outlet openings 170 and 920. Resistive bands in the second column adjacent to 1016 can have a first (upper) end 1017 in proximity to the fluid bath temperature sensor and a second (lower) end 1019 in proximity to the longitudinal axis of the fluid outlet openings 170 and 920. An upper end 1013 of each resistive band in the first column is juxtaposed with an upper end 1017 of a corresponding resistive band from the second column. The flexible circuit board 1000 is wrapped around the heater 210 such that the second (lower) ends of the resistive bands in the first column are in proximity but spaced apart from to the second (lower) ends of the resistive bands in the second column. That is, the flexible circuit board 1000 is wrap substantially all the way around, the main heater 210. The flexible circuit board 1000 can have a non-zero radius of curvature, such as a radius of curvature between one quarter inch and four inches, or between one half inch and two inches, or a radius of curvature between one inch and one and a half inches.

The discussed arrangement allows the plurality of resistive bands to be spaced apart from the fluid outlet openings 170 and 920 and, consequently, from the foam seals 680 and 685 at least by a predetermined distance. Spacing of the plurality of the resistive bands from the foam seals 680 and 685 enables reduction or prevention of the damage to the foam seals 680 and 685 during operation of the thermal immersion circulator, which is particularly advantageous in case of an abnormal heating event.

The thick-film printed circuit board 1000 also comprises a plurality of conductive pathways formed on an electrically insulating base layer. The plurality of conductive pathways can include a first neutral pathway 1030 and a second neutral pathway 1090. The first neutral pathway 1030 electrically couples the first (upper) ends 1013 and 1017 of each resistive band to each other and to a first neutral terminal 1020. The second neutral pathway 1090 electrically couples the second (lower) ends 1015 and 1019 of each resistive band to each other and to a second neutral terminal 1080. The second neutral terminal 1080 can be powered or driven by a 110V-120V or 220V-240V AC power source. An example current flow for the resistive bands is shown in FIG. 10. Specifically, the current may flow from the first neutral terminal 1020, through the resistive bands from the first (upper) ends 1017 and 1013 to second (lower) ends 1019 and 1015 respectively, and then along the second neutral pathway 1090 towards the second neutral terminal 1080.

The power to the thick film circuit board 1000 is supplied from the fuse 675 which is powered by TRIACs.

The thick-film printed circuit board 1000 can also comprise a live terminal 1065 for which the second neutral pathway 1090 and the second neutral terminal 1080 serves as a return path and a return terminal. The live terminal 1065 can be powered or driven by a 110-120V or 220V-240V AC power source. The thick-film printed circuit board 1000 additionally comprises a gate 1060 adjacent to but electrically separated from the live terminal 1065. The gate 1060 can be located above the live terminal 1065, and the live terminal 1065 can be located above the first neutral terminal 1080.

The terminals can be electrically coupled in soldered electrical connection to other electrical components of the thick-film printed circuit board 1000. In particular, the terminal can be solderable so as to allow soldered electrical connection of other electrical components to the thick-film printed circuit board 1000. For example, a controlling active power switch (e.g. TRIAC) is electrically coupled to each end 1070 of the gate 1060, the live terminal 1065 and the first neutral terminal 1020.

The thick-film printed circuit board 1000 can additionally have a heater temperature sensor 1050 coupled to at least some of the resistive bands 1010 (not shown). The heater temperature sensor 1050 can be, for example, a heater thermistor which can be surface mount coupled to tracks formed in the thick-film printed circuit board 1000. Additionally, the heater temperature sensor 1050 is electrically coupled to the PCB 230 and electronics using wires 1040.

The flexible circuit board 1000 also includes a top protective layer that overlays the rest of the electrical components of the printed circuit board 1000 to protect them from water ingress or other potential contaminants.

The flexible circuit board 930 (also shown as 1000) additionally comprises a mechanically crimped thermal fuse, such a thermal fuse 675, supported by a thermal fuse holder, such a thermal fuse holder 670. The thermal fuse 675 is configured to detect the heat caused by over-current due to short circuit or a component breakdown and is also configured to open the circuit in response to the detected heat.

The thermal fuse holder 670 mitigates against desoldering of the thermal fuse 675 during heater runaway and the risk of short circuit. The thermal fuse 675 can have an upper end and a lower end. The upper end of the thermal fuse 675 is electrically coupled to the second neutral pathway 1090 and to the PCB 230. The lower end of the thermal fuse 675 is electrically coupled to the second neutral terminal 1080 and physically soldered to the exterior surface of the heater 210.

The flexible circuit board 930 may not have a pressure sensor since logic controlling the thermal immersion circulator 100 does not require calculating device altitude for temperature limitation.

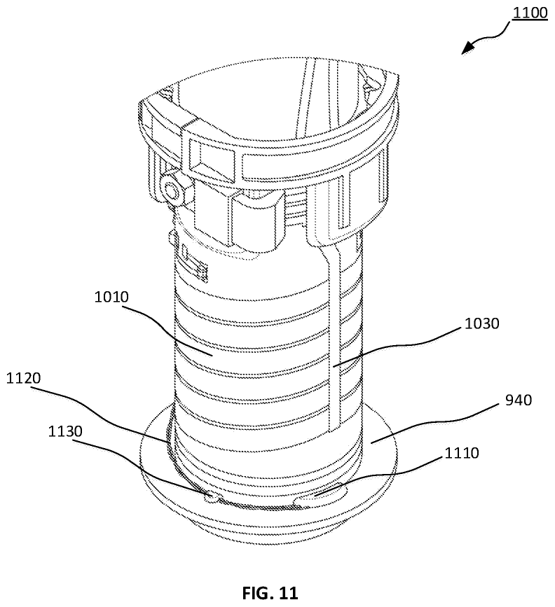

FIG. 11 illustrates the flexible circuit board 1000 coupled to the exterior surface of the heater 210. The flexible circuit board 1000 includes a plurality of resistive bands 1010, which together form a heating element. The flexible circuit board 1000 includes the first neutral pathway 1030 that is electrically coupled first (upper) ends 1013 and 1017 of the resistive bands 1010. The first neutral pathway 1030 is positioned oppositely the fluid outlet openings 170 and 920.

The thermal immersion circulator 100 also includes the fluid bath temperature sensor, such as a fluid bath temperature thermistor 1110, attached to the flange 940 and electrically coupled with the PCB 230 and the electronics module using a wire 1120.

The wire 1120 is secured in position using an adhesive, preferably a UV glue 1130 to hold the wire 1120 in position.

The thermistor 1110 also can be used to determine that the circulator 100 has been removed from a body of fluid. For example, a rate of change of the temperature measured by the thermistor 1110 can be smaller when the circulator 100 is immersed in a body of a fluid than when the circulator 100 is removed from the body of the fluid. A threshold value for the rate of change of the temperature measured by the thermistor 1110 can be pre-determined based on this difference so that when the rate of change of the temperature measured by the thermistor 1110 exceeds the threshold, the heater 210 is turned off to prevent overheating.

The thermal fuse 675 and the thermal fuse holder 670 can be electrically coupled to the second neutral pathway 1090 opposite to the first neutral pathway 1030 and near the fluid outlet openings 170 and 920. In some arrangements, the thermal fuse 675 can include a spring that biases leads from the second neutral pathway 1090 and the second ends of the resistive bands 1010 apart from one another. The thermal fuse 675 can include a conductive element that physically and electrically couples the leads to one another against the action of the spring, and that melts at a predetermined temperature. Once the conductive element melts, the spring can open the circuit across the gap and between the neutral pathway 1090 and the resistive bands 1010.

The flexible circuit board 1000 can be provided with a 120 voltage across the resistive bands 1010, which can produce 1100 watts. Power to the resistive bands 1010 can be cycled on and off over time to provide a desired time-averaged power, such as a time-averaged power less than 1100 watts.

FIG. 12 is a cross-sectional view of several components of the thermal immersion circulator 100.

As shown in FIG. 12, the coupling assembly 250 is secured within the housing 110 using an annular snap fit feature on the mounting frame 231. The coupling assembly 250 in turn secures the heater 210 and other components within the housing 110.

The coupling assembly 250 substantially prevents ingress of fluid from within the heater 210 to the rest of the thermal immersion circulator 100.

The coupling assembly 250 comprises a main body 1205 dimensioned to engage the housing 110 and the side wall 1210 of the heater 210 to secure the heater 210 with respect to the housing 110. The main body 1205 extends between the side wall 1210 and the housing 110 thereby forming a cavity between the side wall and the housing. The coupling assembly 250 also comprises the seal 260 secured on the main body 1205 with respect to the side wall 1210 and the housing 110 and extends around the main body 1205 and into the cavity. The seal 260 comprises at least one laterally extending protrusion 1215 extending outwardly and in contact with the housing 110 and the side wall 1210 to substantially prevent ingress of fluid from outside the circulator 100 to the rest of the thermal immersion circulator 100. The coupling assembly 250 and its seals 260 can allow a user to remove the inlet to access the interior of the heater 210, such as to clean the heater 210, without breaking a seal of the thermal immersion circulator 100.

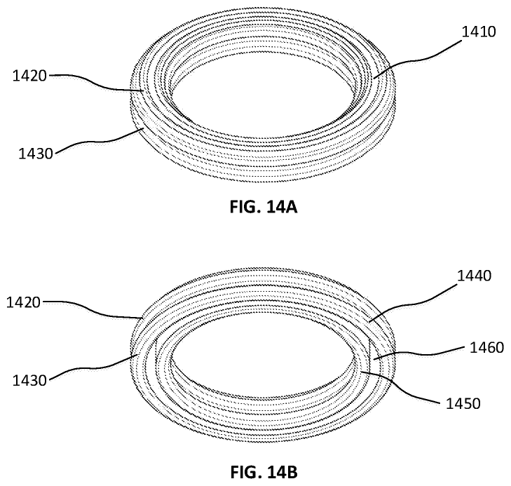

The coupling assembly 250 can also comprise a reinforcement element, such as a protrusion 270, positioned substantially within the seal 260 to reinforce the seal 260 and thereby substantially prevent water ingress into the cavity. The reinforcement element locates the seal 260 and ensures balanced compression of the seal 260 against the housing 110 and heater 210 which is particularly advantageous under abnormal heating conditions. The reinforcement element 270 can be extending vertically away from the main body 1205 along the side wall 1210 into the cavity. As shown in FIGS. 14A and 14B, the seal 260 can comprise an outer sealing portion 1440, an inner sealing portion 1450 and an upper sealing portion 1410 together forming a reinforcement cavity 1460 dimensioned to receive the reinforcement element 270. The seal 260 can be secured on and over the reinforcement element 270. The outer sealing portion of the seal 260 seals the coupling assembly 250 against the housing 110 and the heater 210 to substantially prevent water ingress into the cavity. The upper sealing portion 1410 and the inner sealing portion 1450 of the seal 260 isolate the main body 1205 of the coupling assembly 250 from the heater 210, so as to block heat transfer from the heater 210 to the coupling assembly 250. Without the seal, the heat transferred to the coupling assembly 250 may potentially deform the coupling assembly 250 during operation, and specifically abnormal operation, of the thermal immersion circulator, which can result in water ingress issues.

The side wall 1210 of the heater 210 can comprise a lateral protrusion, such as the flange 280 or 940, extending into the cavity. An underside of the flange 280 is in contact with the upper sealing portion 1410 to secure the seal on and over the reinforcement element 270, the upper sealing portion of the seal 260 isolates the main body 1205 from the side wall 1210. The inner sealing portion and the outer sealing portion of the seal 260 are preferably double-ribbed, e.g. ribs 1420 and 1430 as shown in FIGS. 14A and 14B. Additionally, the upper sealing portion preferably has two or more secondary ribs which can be of smaller height than the ribs of the double-ribbed configuration of the inner sealing portion and the outer sealing portion. The double-ribbed configuration of the seal 260 is particularly advantageous as it has an additional layer of safety if one of the ribs becomes damaged or fails. The seal 260 is preferably removably coupled to the main body 1205 to allow replacement during maintenance of the thermal immersion circulator 100.

The boss 960 (shown as 1220 in FIG. 12) can extend vertically away from the peripheral flange 940 of the heater 210 to be in contact with the radial seal 260. The inner and upper sealing portions of the seal 260 can isolate the heater 210 and the resistive bands 1010 from the coupling assembly 250. The upper portion of the seal 260 is located beneath the underside of the flange 280 or 940. The outer sealing portion of the seal 260 seals the coupling assembly 250 against the housing 110. Each of the inner and outer portions of the seal 260 is preferably ‘double-ribbed’.

The main body 1205 can also comprise at least one protrusion 1330 located on an outer peripheral surface of the main body 1205. The protrusion is coupled to at least one channel located on an inner surface of the housing 110 to locate the coupling assembly 250 within the housing 110. The advantages of the described configuration of the coupling assembly 250 arises from the fact that the coupling assembly 250 no longer relies on tensile load to compress seals and thus eliminates threads on the housing 110 and the main body 1205 of the coupling assembly 250. The above described configuration of the coupling assembly 250 reduces the risk of cracking on the main body of the coupling assembly 250 and the housing 110.

FIG. 12 also illustrates that the housing bumper 241 can be mounted so that a peripheral flange of the housing bumper 241 engages an interior surface of the housing 110 to maintain the housing bumper 241 within the housing 110. The housing bumper 241 can extend out of the housing 110 through an opening in the housing 110, such that a body of the housing bumper 241 protrudes beyond an exterior surface of the housing 110. The housing bumper 241 can be positioned below the seal 260 of the coupling assembly 250 such that the opening in the housing 110 through which the housing bumper 241 extends does not break the seal of the thermal immersion circulator. As shown in FIG. 2, the housing bumper 241 can be positioned on the same side of the circulator 100 as the clip 530, which can be positioned on the opposite side of the circulator 100 from an opening 170 in the side of the housing 110 and a corresponding opening 641 in the side of the heater 210.

The housing bumper 241 can comprise a material that has a higher coefficient of friction than the housing 110 and that is more flexible than the housing 110. Thus, when a user clips the thermal immersion circulator 100 to a side of a container, the body of the housing bumper 241 extending through the opening in the housing 110 can rest against the side of the container, such that the housing 110 is separated and not in contact with the side of the container. Thus, vibrations from the motor 220 and impeller 226 are not transmitted directly (or are at least transmitted more indirectly) to the container. Further, the higher coefficient of friction of the housing bumper 241 reduces movement of the circulator 100 with respect to the side of the container, such chatter of the circulator 100 resulting from the vibrations of the motor 220 and impeller 226. Further, when a user clips the thermal immersion circulator 100 to a side of a container, the opening 170 in the side of the housing 110 and the opening 641 in the side of the heater 210 can face away from the side of the pot, improving fluid dynamics of the fluid as it leaves the thermal immersion circulator 100.

FIG. 12 also shows that the lower inlet assembly 130 coupled to the coupling assembly using screw threads on the internal surface of the main body 1205 of the coupling assembly 250 and complimentary screw threads on the external surface of the lower inlet assembly 130.

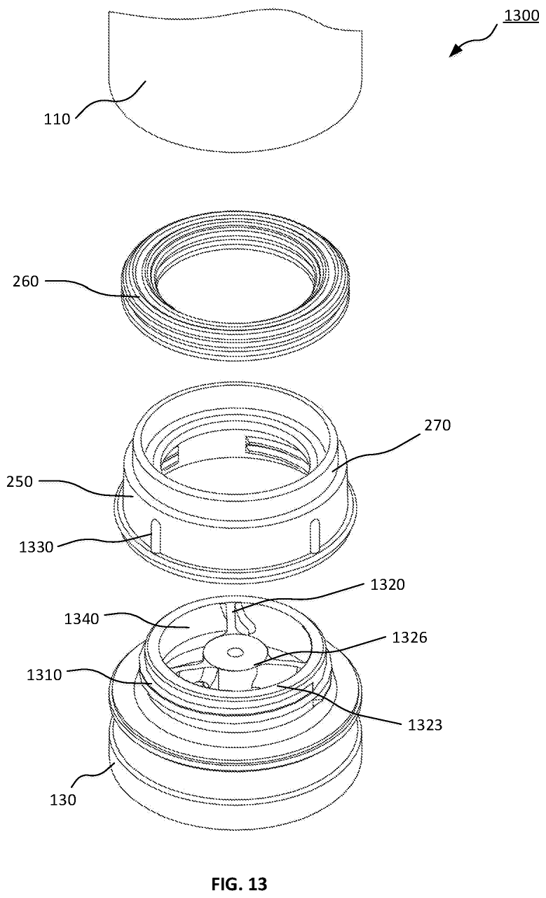

FIG. 13 shows an exploded view of the coupling assembly of and the lower inlet assembly 130. The lower inlet assembly 130 comprises screw threads 1310 disposed on the external surface of the lower inlet assembly 130 to be coupled with complimentary internal threads of the main body of the coupling assembly 250. The lower inlet assembly 130 also comprises a plurality (e.g., three) spokes or struts 1320. The plurality of spokes or struts 1320 couple an outer rim portion 1323 of the lower intel assembly 130 to an inner hub portion 1326. Each of the struts 1320 can extend radially inward and outward between the inner hub portion 1326 and the outer rim portion 1323, and can have an airfoil-shaped body. In some implementations, each of the struts 1320 is also pitched at an angle, or has a generally helical shape about the inner hub portion 1326, so that the struts 1320 form a stationary propeller or an inductor that has a pitch or an angle of attack that is oriented in the same direction, or that is oriented in the opposite direction, as the pitch or angle of attack of the blades of the impeller 226.

As shown in FIG. 13, the main body of the coupling assembly 250 may comprise protrusions 1330 to locate the coupling assembly within the housing 110. The protrusions 1330 are configured to co-operate with channels in the internal surface of the housing 110.

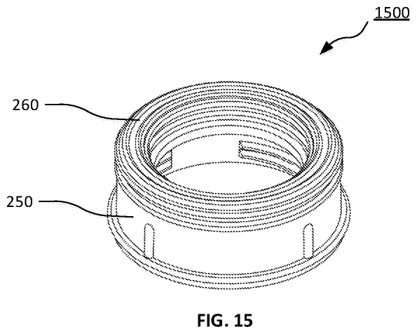

Additionally, as discussed with references to FIG. 12, the seal 260 is configured to be secured on the main body of the coupling assembly 250 over the protrusion 270 of the coupling 1205 in a manner where the protrusion 270 provides reinforcement to the seal 260. The coupling assembly 250 in an assembled configuration is shown in FIG. 15.

When the thermal immersion circulator 100 is in use, the motor 220 can be operated to turn the impeller 226 to draw the fluid being heated into the circulator 100 inward through an entrance of the inlet assembly 130, inward and upward through a flow path 1340 of the inlet assembly 130, upward through the coupling assembly 250 and into the heater 210.

The inlet assembly 130 allows the circulator 100 to stand vertically in a container while resting on the anti-slip pad (not shown), which can be formed from silicone to reduce the chance of the circulator 100 falling over in the container, and allows the circulator 100 to be held to the container by the magnet. In such an embodiment, the clip can be omitted. The inlet assembly 130 also provides an entrance to the circulator at a relatively low elevation so that fluid can be drawn into the circulator 100 even when a fluid level of the fluid being heated is relatively low.

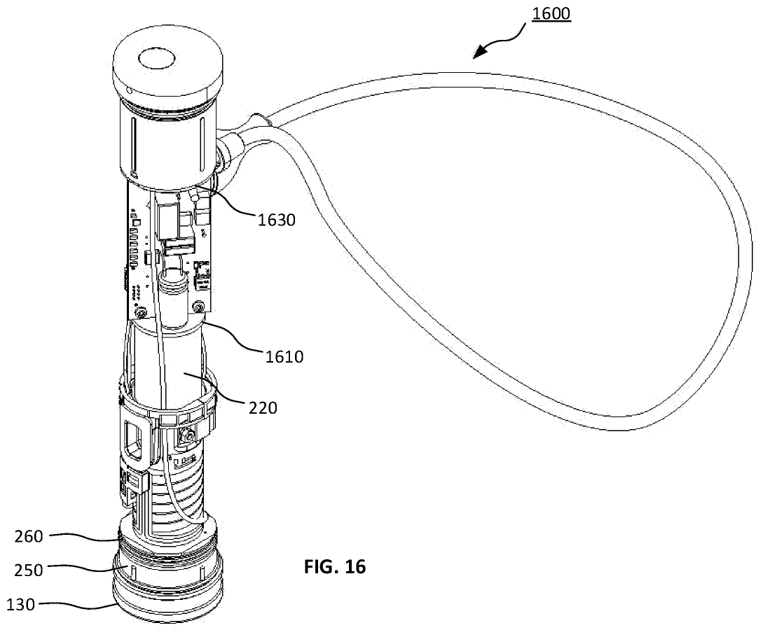

FIG. 16 shows a perspective view 1600 of assembled internal components of the thermal immersion circulator 100. The thermal immersion circulator 100 can have an upper isolation barrier 1630 and a lower thermal isolation barrier 2010. The thermal isolation barriers 1630 and 1610 divide the interior of the thermal immersion circulator 110 into three distinct thermal zones: a first, upper PCBA zone positioned above the thermal isolation barrier 1630, a second, lower PCBA zone positioned in between the upper isolation barrier 1630 and the lower thermal isolation barrier 1610, and a third, motor zone positioned below the lower thermal isolation barrier 1610. The first thermal zone can operate at temperatures at or around 70° C., the second thermal zone can operate at temperatures at or around 100° C., and the third thermal zone can operate at temperatures at or around 100° C. The lower inlet assembly 130 can be removable from the rest of the thermal immersion circulator 100, for example, to facilitate cleaning of the heater 210. Similarly, the top cap assembly 120 can be removable from the rest of the thermal immersion circulator 100, for example, to facilitate access to and repair of the electrical components housed therein.

Any of the thermal immersion circulators described herein can be controlled in any of various suitable ways. For example, a thermal immersion circulator can be communicatively coupled with a source of instructions or commands, for example communicatively coupled with a control subsystem, a terrestrial or satellite broadcaster, or RF or NFC beacons. The communicative coupling can be tethered (i.e., wires, optical fiber, cable(s)). The communicative coupling can be untethered (i.e., radio frequency or microwave frequency transmitters, receivers and/or radios; infrared transmitters and/or receivers).

A thermal immersion circulator may include one or more receivers or ports to receive communications. For example, a thermal immersion circulator can include a USB compliant port to receive communications. The port can be accessible from the exterior of a housing of the thermal immersion circulator. The port can advantageously facilitate communicative coupling between the thermal immersion circulator and an external source of signals or information, for example via one or more wires, ribbon cables, optical fibers, or cables. Such can be used to provide control signals from the external source to the thermal immersion circulator to control operation of the thermal immersion circulator.

A thermal immersion circulator can include a port or receiver or connector or receptacle to receive control signals or other input. For example, a thermal immersion circulator can include a wired port or wired receiver (e.g., Ethernet®, USB®, Thunderbolt®, Lighting®, electrical or optical signaling) to receive signals from an external source. Also for example, a thermal immersion circulator can include a wireless port or wireless receiver (e.g., receiver, transceiver, radio, 802.11 compliant, BLUETOOTH®, WI-FI®, radio frequency, microwave frequency or infrared signaling) to wirelessly receive signals from an external source (e.g., smartphone, tablet computer, server computer, other processor-based device). For instance, a BLUETOOTH® compliant radio can provide short-range wireless communications therebetween. A thermal immersion circulator can include one or more antennas (e.g., stripline RF antenna) for wireless communications.

In some implementations, a thermal immersion circulator can include an internal, integrated input controller, such as coupled to a printed circuit board thereof. Input received by the thermal immersion circulator, by any one of the input methods described herein, can include instructions or commands to turn on a heater of the circulator, to turn off the heater of the circulator, to heat a fluid to a desired temperature, to heat a fluid for a desired amount of time, to heat a fluid to a plurality of different temperatures for a plurality of different times in sequence, or to follow any other suitable sequence of instructions.

The thermal immersion circulator 100 can be used in various applications. In general, the thermal immersion circulators described herein can be used to heat or circulate a body of any fluid that can safely flow through the thermal immersion circulator. As one specific example, the thermal immersion circulators described herein can be used in sous vide food cooking, a technique that cooks food at lower than typical temperatures (e.g., 150-160° F.) for longer than typical times. As another example, the thermal immersion circulators described herein can be used in laboratory settings, such as in environmental, microbiological, or other laboratories.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

In the above description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with the technology have not been shown or described in detail to avoid unnecessarily obscuring descriptions of the embodiments.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its broadest sense, that is, as meaning “and/or” unless the context clearly dictates otherwise.

The headings and Abstract of the Disclosure provided herein are for convenience only and do not limit the scope or meaning of the embodiments.

As used herein, “above” and “below,” “top” and “bottom,” “vertical” and “horizontal,” and other similar terms refer solely to the relative positions of components as they are illustrated in the Figures and are intended to convey their ordinary meaning within the context of the Figures. In some embodiments, these terms can carry their ordinary meaning within the context of real-world implementations, for example, such that gravity pulls an item from a first location above a second location toward the second location. Use of these terms alone, however, is not intended to convey that a first component described as being above another component within the context of the Figures is necessarily above that component in a real-world implementation.

As used herein, “coupled,” “connected,” and other similar terms, when used alone, mean physically coupled or physically connected. Components that are electrically or otherwise “coupled” or “connected” are described as such.

1. A thermal immersion circulator comprising:
a housing defining a cavity;
a heater comprising a heating element, wherein at least a portion of the heating element is located within the cavity of the housing;
a coupling assembly securing the heater within the housing; and a seal isolating the coupling assembly from direct contact with the heater.

2. The thermal immersion circulator according to claim 1, wherein the heater has a side surface, wherein the coupling assembly comprises a main body dimensioned to engage with the housing and the side surface of the heater, the main body extending between the side surface and the housing.

3. The thermal immersion circulator according to claim 2, wherein the seal is secured on the main body of the coupling assembly with respect to the side surface and extends around the main body into a space between the housing and the side surface, the seal comprising at least one laterally extending protrusion extending outwardly and in contact with the housing and the side surface.

4. The thermal immersion circulator according to claim 2 or 3, wherein the main body comprises a reinforcement element extending away from the main body substantially along the side surface into the space between the housing and the side surface, the reinforcement element being positioned substantially within the seal.

5. The thermal immersion circulator according to claim 4, wherein the seal comprises an outer sealing portion, an inner sealing portion and an upper sealing portion together forming a reinforcement cavity dimensioned to receive the reinforcement element.

6. The thermal immersion circulator according to claim 5, wherein the seal is secured on and over the reinforcement element.

7. The thermal immersion circulator according to claim 5 or 6, wherein the outer sealing portion seals the coupling assembly against the housing and the heater to substantially prevent water ingress into the space between the housing and the side surface.

8. The thermal immersion circulator according to any one of claims 5 to 7, wherein the inner sealing portion isolates the heater from the main body of the coupling assembly.

9. The thermal immersion circulator according to any one of claims 5 to 8, wherein the side surface comprises a lateral protrusion extending into the space between the housing and the side surface, an underside of the lateral protrusion being in contact with the upper sealing portion to secure the seal on and over the reinforcement element, wherein the upper sealing portion isolates the main body from the side surface.

10. The thermal immersion circulator according to any one of claims 5 to 9, wherein the inner sealing portion and the outer sealing portion are double-ribbed.

11. The thermal immersion circulator according to claim 2 or any one of claims 3-10 when dependent on claim 2, wherein the main body comprises at least one protrusion located on an outer peripheral surface of the main body to be coupled to at least one channel located on an inner surface of the housing to locate the coupling assembly within the housing.

12. The thermal immersion circulator according to claim 2 or any one of claims 3-11 when dependent on claim 2, wherein the seal is removably coupled to the main body.

13. A heater for a thermal immersion circulator, the heater comprising:
a tubular side wall having longitudinal axis, a fluid inlet in communication with a fluid outlet, and a fluid heating portion located therebetween;
at least one seal located adjacent the outlet; and
a heating element physically coupled to the tubular side wall and wrapped at least partially about the fluid heating portion, the heating element comprising a plurality of resistive bands arranged on the tubular side wall,
wherein a first portion of a resistive band of the plurality of resistive bands adjacent the fluid outlet is longitudinally spaced further from the fluid outlet compared to a longitudinal spacing between the outlet and an opposing second portion of the resistive band arranged on the side wall so as to reduce transfer of heat generated by the resistive band to the seal whilst heating the fluid substantially along a longitudinal length of the fluid heating portion.

14. The heater according to claim 13, wherein the plurality of resistive bands forms a heating surface spaced from the fluid outlet so as to reduce transfer of heat generated by the plurality of resistive bands while occupying substantially the entire fluid heating portion.

15. The heater according to claim 13 or 14, wherein a resistive band adjacent the fluid inlet is spaced at least by a predetermined distance from a fluid bath temperature sensor coupled to the heater so as to reduce interference of heat generated during operation of the heating element upon a temperature measurement of the fluid entering the fluid inlet by the temperature sensor.

16. The heater according to any one of claims 13 to 15, wherein a distance between a top end portion of the heating surface and the fluid inlet varies along the circumference of the tubular side wall to occupy substantially an entire fluid heating portion while being spaced from the seal located about the fluid outlet.

17. The heater according to any one of claims 13 to 16, wherein the plurality of resistive bands comprises at least two columns of resistive bands, each column comprises at least one bottom resistive band adjacent to the fluid inlet and at least one top resistive band adjacent to the fluid outlet.

18. The heater according to claim 17, wherein a distance between each top resistive band and a top end portion of the heater varies along the at least two columns.

19. The heater according to any one of claims 13 to 18, wherein the heating element is a film printed heater, the film printed heater comprises a plurality of conductive pathways formed on the electrically insulating base layer, the plurality of conductive pathways comprising:
a first neutral pathway that electrically couples a first end of each resistive band to each other and to a first neutral terminal; and
a second neutral pathway that electrically couples a second end of each resistive band to each other and to a second neutral terminal;
the film printed heater further comprises:
a live terminal for which the second neutral pathway and the second neutral terminal serves as a return path and a return terminal;
a gate adjacent to and electrically separated from the live terminal.

20. The heater according to claim 19, further comprising a mechanically crimped thermal fuse and a fuse holder, wherein an upper end of the thermal fuse is electrically coupled to the second neutral pathway and to a PCB controlling the device for heating fluid and a lower end of the thermal fuse is electrically coupled to the second neutral terminal and physically soldered to an exterior surface of the side wall.

21. The heater according to claim 20, wherein the terminals are electrically coupled in soldered electrical connection to other electrical components to the film printed heater.

22. The heater according to claim 21, wherein the heating element comprises a heater temperature sensor coupled to at least some of the resistive bands.

23. The heater according to any one of claims claims 19 to 22, wherein the gate is located above the live terminal, and the live terminal is located above the first neutral terminal.

24. The thermal immersion circulator according to any one of claims 1 to 12, wherein the heater is configured according to any one of claims 13 to 23.

25. The thermal immersion circulator according to claim 24, further comprising a motor driving a flow of the fluid from the fluid inlet to the fluid outlet, wherein the motor is mounted within the housing using a front motor mount and a rear motor mount, the rear motor mount comprising an extended portion counterbalancing reactive forces of the seal located adjacent the fluid outlet to substantially prevent dislocation of the motor with respect to the housing.
